(19) United States
(12) Patent Application Publication
(10) Pub. No.: US 2017/0284544 A1
(43) Pub. Date: Oct. 5, 2017

(54) PISTON WITH VARIABLE DEPTH GROOVE ROOT

(71) Applicant: Electro-Motive Diesel, Inc., LaGrange, IL (US)

(72) Inventor: Panchangam Nivarthi Amar Jeetendra, Darien, IL (US)

(21) Appl. No.: 15/084,850

(22) Filed: Mar. 30, 2016

(51) Int. Cl. F16J 1/09; F02F 3/10; F16J 9/20

(52) U.S. Cl. CPC F16J 1/09; F16J 9/203; F02F 3/10

(57) ABSTRACT

A piston for an internal combustion engine includes a cylindrical piston body defining a longitudinal axis and having a top end and an outer cylindrical surface. A first piston ring groove is formed in the outer cylindrical surface and includes a groove root, an upper surface and a lower surface. The groove root has a variable depth about a circumference of the cylindrical piston body.

### TECHNICAL FIELD

The present disclosure relates generally to a piston for an internal combustion engine, and more particularly to a piston having a variable depth groove root for conforming a piston ring to a distorted liner.

### BACKGROUND

The piston, ring and liner combination seals in the combustion gases and extracts power from the same. The seal between the liner and the piston ring is lubricated using oil. One of the major functions of the piston ring is to scrape the lubricating oil on the liner surface downwards and prevent it from burning up in the combustion chamber. The sealing and scraping functions of the ring are achieved as a result of the combustion gas pressure acting on the back of the ring, between the ring and piston groove. The quantum of gas pressure acting on the back of the ring depends on the geometry of the space between the ring and piston. The liner distorts as a result of thermal load on it. This distortion creates an out of round shape that the ring has to conform to in order to perform its functions.

U.S. Pat. No. 8,353,267 to Cha et al. is directed to a piston having a stable behavior of a piston ring. The piston includes an upper ring, middle ring and an oil ring. A ring-shaped groove is formed between the upper ring and the middle ring, with a gap between the piston and inner cylinder wall extending from the ring-shaped groove through the oil ring. The groove and gap permit blow-by gas and oil to flow therein, for stabilizing behavior of the upper ring and the middle ring.

There is a continuing need to provide improved internal combustion engine components providing improved performance, efficiency, or longevity. The present disclosure is directed to such an endeavor.

### SUMMARY OF THE INVENTION

In one aspect, a piston for an internal combustion engine includes a cylindrical piston body defining a longitudinal axis and having a top end and an outer cylindrical surface. A first piston ring groove is formed in the outer cylindrical surface and includes a groove root, an upper surface and a lower surface. The groove root has a variable depth about a circumference of the cylindrical piston body.

In another aspect, a piston assembly for an internal combustion engine includes a piston having a cylindrical piston body and having a top end and an outer cylindrical surface. A first piston ring groove is formed in the outer cylindrical surface and includes a groove root, and upper surface and a lower surface. The piston assembly also includes a piston ring at least partially received within the first piston ring groove, and a cylinder liner receiving the piston and having an inner surface. The groove root has a variable depth about a circumference of the cylindrical piston body.

In yet another aspect, a method of manufacturing a piston for an internal combustion engine is provided. The piston includes a cylindrical piston body and has a top end and an outer cylindrical surface. The method includes a first step of determining identified areas of liner and piston ring non-conformance along an internal surface of a cylinder liner. The method also includes a second step of forming a first piston ring groove in the outer cylindrical surface having a variable depth groove root, the groove root depth varying about a circumference of the cylindrical piston body at areas corresponding to the identified areas of liner and piston ring non-conformance

### BRIEF DESCRIPTION OF THE DRAWINGS

FIG. 1 is a partially sectioned side view of a piston, received within a liner and including piston ring grooves, according to an exemplary embodiment of the present disclosure;

FIG. 2 is a diagrammatic side view of a piston assembly, including the piston and liner of FIG. 1, along with piston rings positioned within the piston ring grooves; and

FIG. 3 is a sectioned view taken along lines 3-3 of FIG. 2, according to another aspect of the present disclosure.

### DETAILED DESCRIPTION

Although an internal combustion engine is not shown or described, the general workings of an internal combustion engine are well known by those skilled in the art. The present disclosure has applicability to internal combustion engines and is described in such a context. However, the concepts disclosed herein may have broader applicability and/or may be more suitable to particular engines than others.

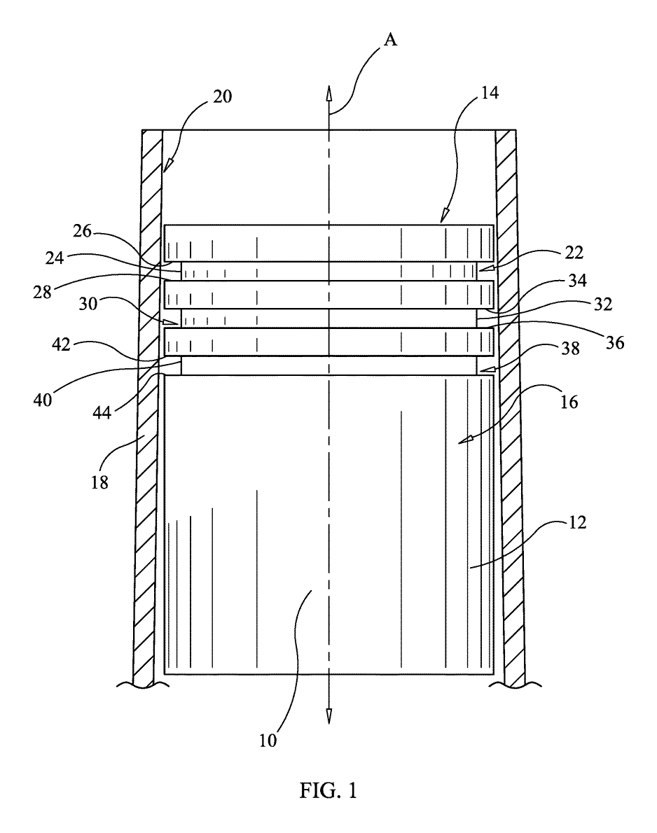

A piston 10 for an internal combustion engine, according to the present disclosure, is shown according to one embodiment in FIG. 1. As should be appreciated, pistons come in a variety of different shapes, sizes and configurations, depending on the particular application. Although a particular example is illustrated, it is not intended to limit the scope of the present disclosure in any way. As stated above, the concepts of the present disclosure may have broad applicability, including applicability to various types of engines and various types of pistons.

The piston 10 shown in FIG. 1 generally includes a solid cylindrical piston body 12 defining, or oriented along, a longitudinal axis A. The cylindrical piston body 12 has a top end 14 and an outer cylindrical surface 16. The shape and materials for piston 10 may vary. According to some embodiments, the piston 10 may be made from cast iron, cast steel, forged steel, a cast aluminum alloy and/or a forged aluminum alloy. The materials may be selected based on desired performance of the piston 10 and ease of manufacturability.

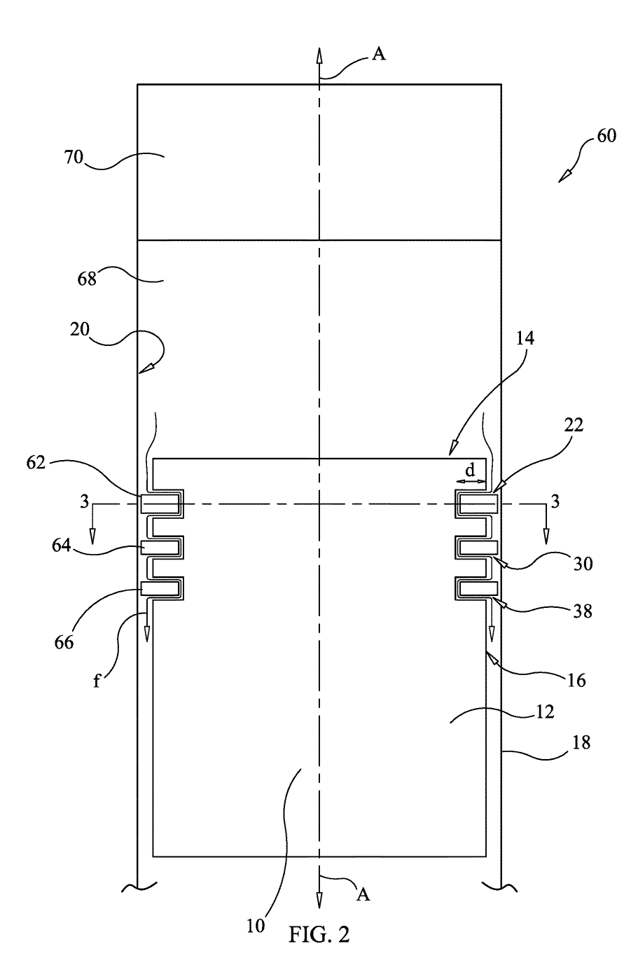

The piston 10 is configured to move along axis A within a cylinder (not shown) of an internal combustion engine. The cylinder may be provided with a liner 18, or sleeve, which directly receives the piston 10. The liner 18 may protect the cylinder and is typically fitted into an engine block to form the cylinder. The liner 18 serves as the inner wall of the cylinder and defines an inner sliding surface 20 for one or more piston rings (not shown). Piston rings, which will discussed with reference to FIG. 2, may be received within openings or grooves of the piston 10.

The piston 10 may include a first piston ring groove 22 formed in the outer cylindrical surface 16. The first piston ring groove 22 may generally include a groove root 24, an upper surface 26 and a lower surface 28. According to the exemplary embodiment, the upper surface 26 and the lower surface 28 are substantially parallel. The groove root 24, which will be discussed in greater detail below, may be substantially parallel with the longitudinal axis A. Although a particular shape, number and configuration of grooves is shown, it should be appreciated that the teachings described herein may be applied to a wide range of different pistons, having different piston ring groove configurations.

As shown, the piston 10 may include a second piston ring groove 30 formed in the outer cylindrical surface 16 of the cylindrical piston body 12. The second piston ring groove 30 may be spaced below the first piston ring groove 22 relative to the longitudinal axis A. In particular, the first piston ring groove 22 may be positioned closer to the top end 14 than the second piston ring groove 30. The second piston ring groove 30 may also include a groove root 32, an upper surface 34 and a lower surface 36.

According to the exemplary embodiment, the piston 10 may also include a third piston ring groove 38. The third piston ring groove 38 may be similar to both the first piston ring groove 22 and the second piston ring groove 30, including a groove root 40, an upper surface 42 and a lower surface 44. The third piston ring groove 38 may be positioned below the first and second piston ring grooves 22, 30, with the second piston ring groove 30 positioned between the first and third piston ring grooves 22, 38 relative to the longitudinal axis A.

Turning now to FIG. 2, a piston assembly, according to the present disclosure, is shown generally at 60. The piston assembly 60 may include the piston 10 and liner 18 of FIG. 1 and also first, second and third piston rings 62, 64 and 66. That is, the first piston ring 62 may be received at least partially within the first piston ring groove 22, while the second piston ring 64 may be received within the second piston ring groove 30 and the third piston ring 66 may be received within the third piston ring groove 38. Although three piston rings 62, 64, 66 and three piston ring grooves 22, 30, 38 are shown, it should be appreciated that the piston 10 may include an alternative number and/or arrangement of rings and grooves.

Although each of the piston rings 62, 64 and 66 are shown and discussed as being similar, it should be appreciated that the piston rings 62, 64 and 66 may be different, depending on the particular application. According to some embodiments, the piston rings 62, 64, 66 may be substantially cylindrical; however, alternative shapes are also contemplated. The piston rings 62, 64, 66 may be continuous or dis-continuous (e.g., split rings).

The piston rings 62, 64, 66 may function to seal a cavity 68 formed between the piston 10 and cylinder, as defined by the liner 18 and cylinder head 70. As should be appreciated, gaps between the piston 10, liner 18 and piston rings 62, 64, 66 should be such that the cavity 68 is sufficiently sealed off and the piston 18 is permitted to move relative to the liner 18 with minimal frictional forces. The piston rings 62, 64, 66 assist with this important function of sealing the cavity 68, and also control an oil supply to the liner 18, which lubricates the piston assembly components.

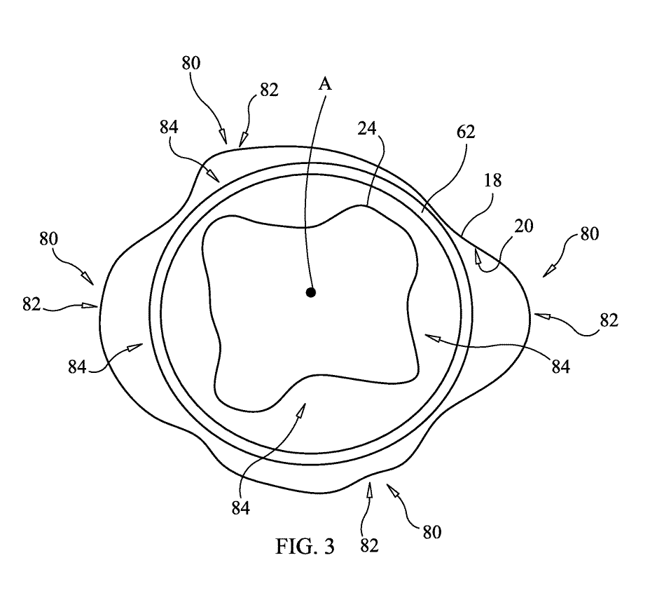

Turning now to FIG. 3, a view taken along lines 3-3 of FIG. 2 is shown. Included in the illustration are the first piston ring 62, the groove root 24 and liner 18. According to the present disclosure, the groove root 24 has a variable depth about a circumference of the cylindrical piston body (12 in FIGS. 1 and 2). A depth d of the groove root 24 is shown generally in FIG. 2 and represents depth d of the groove root 24 relative to the outer cylindrical surface 16 of the piston 10. As is shown in an exaggerated view in FIG. 3, the depth d of the groove root 24 may be inconsistent about the circumference of the piston 10.

As a result of operation of the internal combustion engine and, thus, piston 10, the liner 18 and first piston ring 62 may develop areas of high non-conformance, i.e., identified areas of liner and piston ring non-conformance, identified generally at 80. This non-conformance, which may result in poor operation or performance of the piston assembly 60, may result from a number of different conditions, including liner distortion, piston ring stiffness, and gas flow/pressure on the piston ring 62. For example, as shown in FIG. 3, the identified areas of liner and piston ring non-conformance 80 may correspond to areas of liner distortion 82, e.g., areas where the inner surface 20 of the liner 18 is distorted outward, or away from the piston 10.

According to one aspect of the present disclosure, the depth d of the groove root 24 may be greater at areas around the circumference corresponding to the identified areas of liner and piston ring non-conformance 80. As shown, the increased depth of the groove root 24 at the identified areas of liner and piston ring non-conformance 80 is depicted as the groove root 24 being moved inwardly or farther away from the piston ring 62. These areas of greater depth d of the groove root 24 about the circumference of the cylindrical piston body 12 define areas of higher gas flow, shown generally at 84, between the piston ring 62 and the groove root 24 relative to remaining areas of the groove root 24.

Typical gas flow f is shown in FIG. 2. Combustion gases within the cavity 68 pass between the liner 18 and the piston 10. When the gas flow f passes behind the piston rings 62, 64, 66, the piston rings 62, 64, 66 are urged outward and toward the inner surface 20 of the liner 18. At areas of higher gas flow 84 (FIG. 3), as taught by the present disclosure, the piston ring 62 may be urged more at the identified areas of liner and piston ring non-conformance 80, which may include areas of liner distortion 82. As a result, the piston ring 62 may be pushed more into the distorted liner 18 (i.e., radially outward) at these areas 80 and may, thus, provide better sealing and oil scraping on the liner 18.

Although the variable depth groove root 24 is only discussed with respect to the first piston ring 62, it should be appreciated that additional piston rings, such as piston rings 64 and 66, may also be positioned within corresponding grooves having variable depth groove roots. As should be appreciated, each variable depth groove root 24, including the various depths and shape, will need to be optimized in combination with the piston ring geometry, liner distortion and surface finish.

To manufacture the piston 10 disclosed herein, the areas of liner and piston ring non-conformance 80 along the internal surface 20 of the cylinder liner 18 need to be identified or determined. For example, the non-conformance may be identified using a known simulation technique, which may include identifying a baseline using various test results. Areas of liner distortion 82 may be identified using Finite Element Analysis (FEA) modeling, as is known in the art. Liner distortion may occur in part due to manufacturing and/or assembly and in part due to operational conditions. The distortion that occurs around the circumference may be due to varied cooling and non-uniform structural stiffness around the same.

Once the identified areas of liner and piston ring non-conformance 80 are determined, the first piston ring groove 22 is formed in the outer cylindrical surface 16 to have the variable depth groove root 24. The variable depth groove root 24 may be machined to have variable depth about the circumference of the piston 10, or may be formed using any other known method. As described above, the variable depth groove root 24 varies about the circumference of the cylindrical piston body 12 at the areas corresponding to the identified areas of liner and piston ring non-conformance 80 and/or areas of liner distortion 82.

Areas of non-conformance have been identified as being consistently in similar locations. However, magnitudes of such non-conformance may vary depending on various factors. Liner distortion, resulting in non-conformance, may occur in the first few cycles of the engine and may remain relatively constant for a steady state operation.

### INDUSTRIAL APPLICABILITY

The present disclosure is applicable to pistons of internal combustion engines. The present disclosure is further applicable to internal combustion engines having cylinders and cylinder liners, and more particularly applicable to such engines also having issues with non-conformance between piston rings and liners. As described above, most engines may be susceptible to these issues.

Referring generally to FIGS. 1-3, a piston assembly 60 generally includes a piston 10, liner 18 and one or more piston rings 62, 64, 66. The piston rings 62 64, 66 assist with sealing a chamber or cavity 68, defined by the piston 10, liner 18 and head 70, and also assist with scraping lubricating oil from the inner surface 20 of the liner 18. Due to areas of non-conformance 80, occurring as a result of normal operation and/or other conditions, performance of the piston assembly 60 may be compromised.

To improve sealing and scraping performed by the piston rings 62, 64, 66, one or more of the piston rings may be received within a piston ring groove 22 having a variable depth groove root 24. According to the present disclosure, the depth d of the groove root 24 may be greater at areas around the circumference corresponding to the identified areas of liner and piston ring non-conformance 80, which may include areas of liner distortion 82.

These areas of greater depth d of the groove root 24 about the circumference of the cylindrical piston body 12 define areas of higher gas flow, shown generally at 84, between the piston ring 62 and the groove root 24 relative to remaining areas of the groove root 24. At areas of higher gas flow 84 (FIG. 3), as taught by the present disclosure, the piston ring 62 may be urged more at the identified areas of liner and piston ring non-conformance 80, which may include areas of liner distortion 82. As a result, the piston ring 62 may be pushed more into the distorted liner 18 (i.e., radially outward) at these areas 80 and may, thus, provide better sealing and oil scraping on the liner 18.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A piston for an internal combustion engine, comprising:
a cylindrical piston body defining a longitudinal axis and having a top end and an outer cylindrical surface; and
a first piston ring groove formed in the outer cylindrical surface, wherein the first piston ring groove includes a groove root, an upper surface and a lower surface;
wherein the groove root has a variable depth about a circumference of the cylindrical piston body.

2. The piston of claim 1, wherein a depth of the groove root is greater at areas around the circumference corresponding to identified areas of liner and piston ring non-conformance.

3. The piston of claim 2, wherein the identified areas of liner and piston ring non-conformance correspond to areas of liner distortion.

4. The piston of claim 2, further including a second piston ring groove formed in the outer cylindrical surface and spaced along the longitudinal axis from the first piston ring groove.

5. The piston of claim 4, wherein the first piston ring groove is positioned closer to the top end of the cylindrical piston body than the second piston ring groove.

6. The piston of claim 1, wherein the upper surface and the lower surface are substantially parallel.

7. A piston assembly for an internal combustion engine, comprising:
a piston having a cylindrical piston body and having a top end and an outer cylindrical surface, a first piston ring groove formed in the outer cylindrical surface, wherein the first piston ring groove includes a groove root, an upper surface and a lower surface;
a piston ring at least partially received within the first piston ring groove; and
a cylinder liner receiving the piston and having an inner surface;
wherein the groove root has a variable depth about a circumference of the cylindrical piston body.

8. The piston assembly of claim 7, wherein the inner surface of the cylinder liner has identified areas of liner and piston ring non-conformance; and wherein a depth of the groove root is greater at areas around the circumference corresponding to the identified areas of liner and piston ring non-conformance.

9. The piston assembly of claim 8, wherein the identified areas of liner and piston ring non-conformance correspond to areas of liner distortion.

10. The piston assembly of claim 8, wherein the upper surface and the lower surface are substantially parallel.

11. The piston assembly of claim 7, wherein the piston ring is substantially cylindrical.

12. The piston assembly of claim 7, wherein areas of greater depth of the groove root about the circumference of the cylindrical piston body define areas of higher gas flow between the piston ring and the groove root relative to remaining areas of the groove root.

13. The piston assembly of claim 12, further including a second piston ring groove formed in the outer cylindrical surface.

14. The piston assembly of claim 13, wherein the first piston ring groove is positioned closer to the top end of the cylindrical piston body than the second piston ring groove.

15. A method of manufacturing a piston for an internal combustion engine, wherein the piston includes a cylindrical piston body and has a top end and an outer cylindrical surface, the method comprising steps of:
determining identified areas of liner and piston ring non-conformance along an internal surface of a cylinder liner; and
forming a first piston ring groove in the outer cylindrical surface having a variable depth groove root, varying about a circumference of the cylindrical piston body at areas corresponding to the identified areas of liner and piston ring non-conformance

16. The method of claim 15, wherein the determining step includes identifying areas of liner distortion.

17. The method of claim 15, further including forming a second piston ring groove in the outer cylindrical surface.

18. The method of claim 17, further including positioning the first piston ring groove closer to the top end than the second piston ring groove.
